(19) United States
(12) Patent Application Publication
(10) Pub. No.: US 2022/0376917 A1
(43) Pub. Date: Nov. 24, 2022

(54) DYNAMIC PASSWORD CIPHER

(71) Applicant: Focus Universal Inc., Ontario, CA (US)

(72) Inventor: Desheng Wang, Diamond Bar, CA (US)

(21) Appl. No.: 17/747,887

(22) Filed: May 18, 2022

Related U.S. Application Data
(60) Provisional application No. 63/190,572, filed on May 19, 2021.

(51) Int. Cl. H04L 9/32; G06F 21/62; H04L 9/06

(52) U.S. Cl. CPC H04L 9/3226; G06F 21/62; H04L 9/0637

(57) ABSTRACT

Disclosed is a method for creating one or more passwords, each in compliance with website or file requirements, from a single password containing only letters. Several parameters, including the total number of characters, any type of required character, including capital letters, digits, and special characters, and the number of each type of required character are entered in to a cipher algorithm. The cipher algorithm creates a set of possible characters from the letters of the alphabet, digits, and any special characters. According to the ruleset for the character position, the available characters from the set are made available for assignment for a predetermined period, and assigned by keystroke.

### CROSS-REFERENCE TO RELATED APPLICATIONS

The present application claims the benefit of priority to U.S. Provisional Patent Application No. 63/190,563, filed May 19, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to security for passwords on automated systems.

### BACKGROUND

Passwords are commonly used in security automation. Passwords may be used to allow access to encrypted files, and access to webpages, and accounts for particular webpages. For example, account information, including personally identifiable information (PII) and financial information such as credit card numbers. Such information may be stored in a secure file, which may only be accessed by entering a correct password. Thus, security levels are increased through the use of passwords.

However, passwords are often terms, such as words, names, and dates that are easily remembered by a user. This fact makes passwords easier to guess for criminals wishing to obtain the information protected by the passwords. Rather than having to use “brute force” methods, that is, try every possible combination to ensure finding the password, the criminals can start with such terms and obtain the password with much less effort.

Many websites and programs now include minimum requirements for passwords. These minimum requirements may include that the password must contain a minimum number of characters. The requirements often include that passwords include a mix of alphabetical characters and numerical digits. In some cases, a user is required to include at least one special character in the password. Of course, each of these requirements, as to total number of characters, the type of character, either alphabetical or numeric, and the special characters, which are neither alphabetical or numeric, increase the complexity of the password, which makes the password more difficult to guess for hackers and criminals. Instead, these criminals and hackers would have to use brute force techniques to obtain passwords, which requires enough effort to often make doing so impractical. This is good for the security of the password, and, by extension, the user.

However, all the increased complexity makes it harder for a user to remember the password, because it divorces the password from everyday use. This complexity can be compounded by a further requirement. Particularly, in at least some instances, there exists a requirement for the user to change their password after the passage of a predetermined time period. For example, a user may be forced to change their password after a predetermined period of time. This means that every six months the user must change their password. In some instances, requirements exist specifying exactly how much the password must change. Sometimes, these requirements are as extensive as those for initial creation of the password. The result is that the user has a difficult time remembering passwords. Multiple complex, changing passwords are inherently difficult to remember, especially those that are used less frequently. For the foregoing reasons, there is a need for a dynamic password cipher which will allow a user to create multiple passwords from a single password.

### SUMMARY

Disclosed herein is method for encoding passwords using a dynamic cipher. The method may include loading a cipher algorithm on to a non-transient memory. The method may further include inputting a total number of characters included in a password to the cipher algorithm. The method may also include inputting whether one or more capital letters are required for inclusion in the password, and if the input indicates capital letters are required for inclusion, how many capital letters are required for inclusion. The method may further include inputting whether one or more numbers are required for inclusion in the password, and if the input indicates numbers are required for inclusion, how many numbers are required for inclusion. The method may further include inputting whether one or more special characters are required for inclusion in the password, and if the input indicates numbers are required for inclusion, inputting the special characters available for inclusion. The method may also include forming the alphabet, digits 0 through 9, and the special characters, if any are input, in to a group of available cipher characters. The method further includes scrolling, automatically, through the group of available cipher characters, each character in the group of available cipher characters available for assignment by keystroke during a predetermined time interval. The method further includes initiating the creations of the cipher by assigning the cipher character available for assignment to a plain text letter by making a keystroke on an input device. The method further includes executing additional keystrokes to assign characters available for assignment to each of the other characters of the password. The method further includes creating a secure file including the cipher.

Further disclosed is a method for encoding passwords using a dynamic cipher. The method may include loading a cipher algorithm on to a non-transient memory. The method may include inputting a total number of characters included in a password to the cipher algorithm. The method may further include inputting character type requirements within the password to the cipher algorithm. The method may further include forming the alphabet, digits 0 through 9, and the special characters, if any are input, in to a group of available cipher characters. The method may further include scrolling, automatically, through the group of available cipher characters, each cipher character in the group of available cipher characters available for assignment by keystroke during a predetermined time interval. The method may further include initiating the creation of the cipher by assigning the cipher character available for assignment to a plain text letter by making a keystroke on an input device attached to a computing device. The method may further include executing additional keystrokes to assign cipher characters available for assignment to each of the other characters of the password. The method may further include creating a secure file including the cipher.

Further disclosed is a method for dynamically creating a second password from a first password. The method may include determining a total number of characters in a password. The method may further include assigning positions to each character in the password. The method may further include determining requirements for the password, including a number of capital letters, a number of digits, and a number of special characters. The method may further include inputting, if any are required, a list of special characters. The method may further include using a random number generator determining a character position for each of the capital letters, digits, and special characters required. The method may further include assigning one of a corresponding capital letter, digit, and special character ruleset to each of the assigned character positions within the password. The method may further include assigning a global ruleset to the each of the unassigned character positions within the password. The method may further include using the letters of the alphabet, digits 0 through 9, and, if required, the input list of special characters to create a set of cipher characters. The method may further include randomizing the set of cipher characters. The method may further include changing the cipher character available for assignment according to the ruleset assigned to each character position through a keystroke by maintaining the availability of each of the cipher characters in the set of cipher characters for a predetermined time period. The method may also include assigning the password by making a keystroke of an input device for each of the character positions in the password, the keystroke assigning one cipher character of the set of cipher characters to the plain text character corresponding to the input device key.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an example of an extended homophonic substitution cipher;

FIG. 2 shows in index view of the relationship of FIGS. 2a and 2b;

FIG. 2a shows a first portion of a flowchart of a method;

FIG. 2b shows a second portion of a flowchart of a method; and

FIG. 3 shows a keyboard with a display which may be used in implementing the method.

### DETAILED DESCRIPTION

The detailed description set forth below in connection with the appended drawings is intended as a description of the presently preferred embodiment of a system and method to provide security for payment cards, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

Because of the massive amount of hacking and online fraud, many websites and computer systems require passwords. Moreover, many require complex passwords, including large sets of characters, which often include letters, capital letters, numbers, and special characters. The method disclosed herein allows a user to enter the same password, but have that password filtered by a dynamic cipher. The dynamic cipher generates multiple passwords from the single password. Further, the rules for the cipher may be modified to meet any system's requirements.

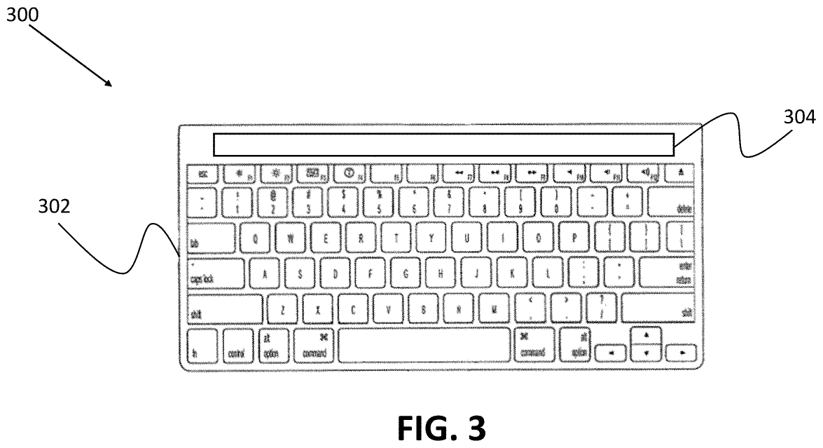

The method can be implemented either using software alone, or a combination of hardware and software. As shown in FIG. 3, a keyboard 300 either includes a dynamic extended mixed alphabet cipher using homophonic substitution or is linked to a software application which includes a dynamic extended mixed alphabet cipher. When implemented as hardware, the keyboard may have a housing 302, a memory (not shown), a processor (not shown), and a display 304. The cipher algorithm may be stored in the memory, and execute on the processor. The keyboard may have a hardware button to activate the cipher function. When the button is pressed, the cipher algorithm activates a software switch which prevents the keyboard from inputting to the computing device to which it is attached. The input instead goes to the cipher algorithm running on the keyboard itself, with prompts displayed on a display integral with the keyboard.

The cipher included in the cipher algorithm is an extended mixed alphabet cipher. An extended mixed alphabet cipher using homophonic substitution is a cipher that may assign one or more letters, digits, or special characters to each of the letters of the alphabet to encode information, in this case a password. More letters are assigned to more frequently used characters to make an attempt to break the cipher using frequency analysis more difficult.

Before any encoding, some preliminary parameters may be input in to the cipher algorithm. For example, if the password is required to be a certain number of characters, that value may be input to the cipher algorithm through an input device, as just one example, a keyboard, as is described in detail below. Alternatively, if the user is already aware of the password the user wishes to use, then the user may count the number of letters in the intended password and input that number. For example, often times there is a requirement that a password contain at least a certain number of characters. The user's intended password may contain more than that number of characters. The user may have the additional characters because that combination is easier to remember while still meeting the requirement that the password be at least a certain number of characters. The information regarding the number of characters in the password will make it easier to assign all the characters used in the cipher, as is described in detail below.

Additionally, the user may enter other parameters for the cipher which are driven by password requirements. For example, the file for which the user is creating the password may require that the password contain a certain number of different types of characters, as well as an overall number of characters. These requirements with direct the cipher so that it meets the password requirements automatically, thus leaving the user free to key in a natural language word or phrase as a password.

Initially, the cipher is not set. That is, none of the characters are assigned to letters of the alphabet. Rather, all of the available characters are cycling through an availability protocol, which is part of the cipher algorithm. Each character may be available for capture for a fraction of a second. When the user makes a keystroke, the character available for capture is assigned to the password. By way of example and not limitation, each character may be available for a tenth of a second. When the user makes a keystroke, at contact of the key, the current character is captured for inclusion in the code. Depending on the character, as is explained in further detail below, this may be the only character assigned to that letter, or may be one of a plurality of characters assigned to that letter. Once the first character is assigned, the remaining characters continue to cycle through availability, awaiting the next key stroke.

The user makes the next keystroke, and again, the next on cycle character is assigned to that letter. This method of assignment continues until the entirety of the password has been typed.

More specifically, if the user has input requirements that the password contain a specific number of required characters, the cipher algorithm may prompt the user to enter the total number of characters in the password. In preparation for additional parameters, the cipher algorithm may also create and number character positions for each character in the password, For example, if a password has N characters, the first character is position one, the next character is position two and so on until position N is reached.

The cipher algorithm may include a ruleset for each of the types of required characters. For example, there may be a requirement that a password contain at least one capital letter. Thus, the cipher algorithm may assign a capital letter to the first character position of the password. The cipher may include both the capital and lower case letters assigned to a single input letter. For example, if the first letter input by the user is an “s,” and the cipher is cycling through the letter “i” when the keystroke is made, then the cipher may assign a “I” as the first letter of the password, and also assign “i” for subsequent use. If “e” is the next letter typed by the user, and “p” is cycling through as the keystroke is made, the cipher may assign “p” as the second character of the password, and “P” is also assigned for potential subsequent use. Thus, if a letter is assigned as one of the characters of the password, both the capital and lower case versions of the letter are assigned, and both point to back to the same letter entered by the user. Alternatively, the capital letters may be assigned apart from the lower case. For example, the capital “I” may be assigned to a plain text “s” by keystroke, and a lowercase “i” assigned to the plain text letter “w” by keystroke.

The password may also require numerical digits be included in the password. For example, a system may require that two numerical digits be included in the password. When the user enters this parameter, the cipher algorithm uses a random number generator to determine which of the characters will be numeric characters. For example, if there are eight total characters, the random number generator may determine that the third and seventh characters will be numeric characters. When the user goes to enter the third character of the password, the algorithm checks if any numeric characters have already been randomly assigned. If not, then the cipher cycles through all of the digits 0-9. If one has been used, then the cipher cycles through all of the remaining numeric digits. When the user makes a keystroke, a numeric digit is assigned to character three. The cipher then moves to character four, cycling through all the remaining characters, alphabetical, numerical, and special until a keystroke is made, and a character chosen. The same for characters five and six. When the cipher reaches character seven, again the cipher algorithm cycles only the remaining numeric characters until a keystroke is made, and a numeric character assigned.

If special characters are required as part of the password, the information regarding their requirements may also be input before the password is created. There may be a required number of special characters in the password. There may also be only certain special characters allowed. For example, “$” may be an allowed special character, but “*” may be disallowed. In the case that the special characters are restricted to certain ones of the special characters, the cipher algorithm would require the user to input the special characters which are allowed. Using the input information, the cipher algorithm may include the special characters in the possible characters for each of the characters in the passcode, and, using a random number generator, may determine which characters in the password will be special characters. For example, if the password is 10 characters, the random number generator may determine that characters positions four and seven are to be the character positions reserved for the special characters.

The procedure for determining the special characters is similar to that of determining the numbers in the password. That is, the special characters may be included in the scrolling list of possible characters for any non-assigned character slot, and potentially assigned when the user presses a key. When the assigned special character positions are reached, the algorithm determines if a special character has been assigned in one of those positions and removes that special character from the list of available special characters. If a special character is assigned in a non-assigned position, the cipher algorithm may simply assign different special characters in the assigned special character positions. Alternatively, the cipher algorithm may have instructions that for each special character which is assigned in a global position, one of the assigned special character positions is converted to a global position. Thus, if no special characters have been assigned in the first, second or third global positions in the example above, the cipher algorithm moves to the fourth character position, and the scrolling list of possible characters is reduced to only the special characters. When the user presses a key, the special character currently available on the scrolling list is assigned. The cipher algorithm then moves to the fifth character position. The fifth character position is a global position, and all unused special characters are included with all other the other unused characters in determining the character assigned to the fifth character position. The same for the sixth character position. If any special characters need to be assigned when the cipher algorithm gets to the seventh character position, the cipher algorithm may again reduce the list of available characters to the remaining special characters. When the user makes a keystroke, a special character is selected from the scrolling list. With the special character requirement filled, the cipher algorithm moves to the eighth character position, which is a global character position.

Once the user has completed entering all of the characters of the password, the remaining characters may be assigned according to a modified homophonic substitution. The homophonic substitution is modified by extending it to include the specified special characters. As in a typical homophonic substitution, the numerical digits may be assigned along with the letters of the alphabet. The special characters may also be assigned to letters to make frequency analysis less effective in cipher cracking attempts.

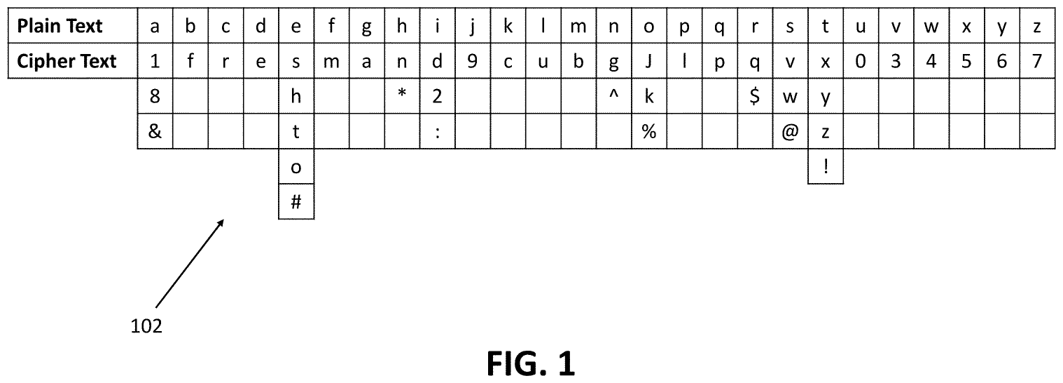

As shown in FIG. 1, a homophonic substitution 102 of this disclosure uses the digits 0-9 in addition to the letters of the alphabet. Because this is more than 26 characters total, the homophonic substitution in a mixed alphabet cipher assigns two characters to the letter “a,” four characters to the letter “e,” two to the letter “i,” two to the letter “n,” two to the letter “o,” two to the letter “s,” and three to the letter “t.” The special characters simply add to the total number of characters which may be assigned to the plain text letters. Because it is not known exactly how many special characters may be included before a user enters them, the cipher algorithm may include a ruleset as to which alphabet letters get assigned either a second, or more, character of the pool of special characters.

The rules for distributing the special characters may establish a priority list for placement of the special characters in the cipher in relation to the letters of the unencoded, or plain text, alphabet. The ruleset may include that if there is at least one special character, then the letter “h” may receive a second character in addition to the single character already assigned. If there are two special characters, the letter “r” may receive a second character in addition to the single character already assigned. The entirety of the priority list for assigning letters may be, in order of priority from highest to lowest, h, r, e, t, a, o, i, n, and s. If there are additional special characters, the priority list may repeat, meaning that additional characters may be assigned, in order, to h, r, e, t, a, o, i, n, and s. If the list has repeated twice, an additional character may be assigned to the letter “d” before additional characters are assigned to the above priority list again. If there are still more special characters, the letter “d” may receive another cipher character, and then the priority list repeated again for additional assignments until all cipher characters are assigned to plain text characters.

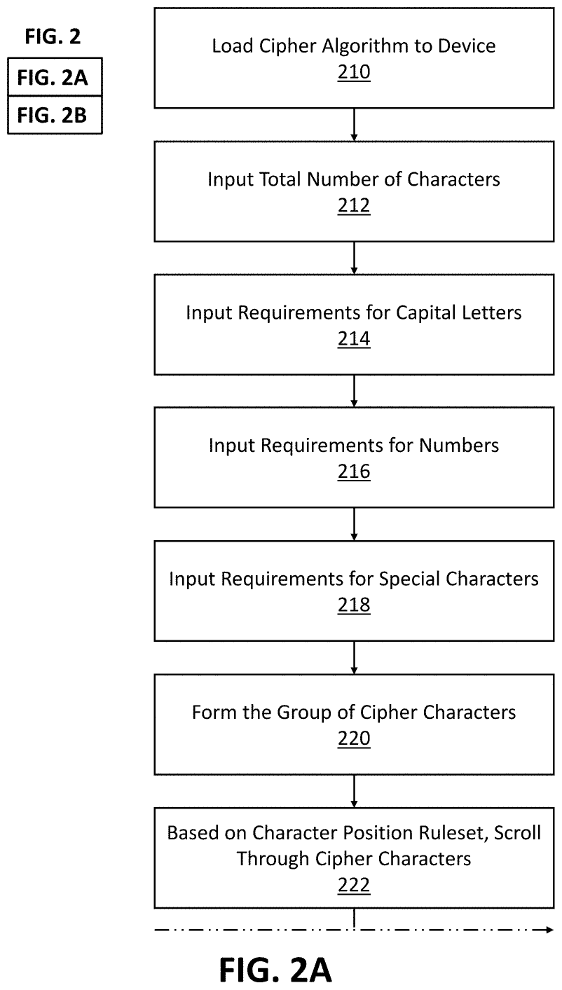

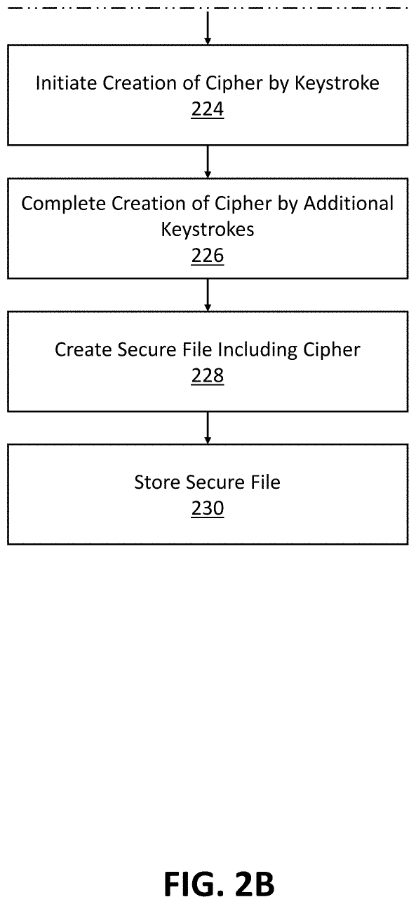

In operation, as shown in Step 210 of FIG. 2A, the disclosure may be implemented as either a combination of standalone software running on standalone hardware, or software interacting with an input device, for example a hardware keyboard, a virtual keyboard, text input with a stylus, text input with a light pen, or any other method of text input, or a combination of hardware with integral software and software running on a computing device. For example, in the combination, the software may be divided between the keyboard and on the computing device to which the keyboard is attached. The computing device may be a desktop or laptop computer, a tablet, a smart phone, or any other device which requires password input and accepts that input from either a virtual or physical keyboard, or other hardware input device. The cipher algorithm may be uploaded during or after manufacture of the hardware.

A cipher creation cycle may begin after a local file or website requests that a password be created. Based on the request for creation of a password, the cipher algorithm initiates with the cipher algorithm requesting certain input. This request may be made by the software, either in a window open on a computer screen or on a display built in to the keyboard. As shown in Step 212, the first prompt or request from the cipher algorithm may be for the user to enter how many characters are in the password. For at least some passwords, the only password requirement is that the password contain at least a certain number of characters. In order to properly create a password and the associated cipher, the user must choose a plain text password which meets or exceeds this required number of characters. The plain text password being the password that the user enters by entering text, for example by making a keystroke. Although keystroke is used here because it is the most common method of text entry, it is understood that a keystroke may refer to any method of entering a single character of plain text. The plain text password may be more than a single word. The words may be combined without spaces, or, if allowed, a special character, for example, an underscore, may be used to separate the plain text words. The plain text password may include any letter. The plain text password may be more than one word, and may not follow the rules of conventional grammar, for example, capitalization, or hyphenation.

The user would first choose a password that fits the length of characters requirement and count the number of characters so that number could be input as a parameter for the cipher algorithm. By way of example and not limitation, there may be an eight character requirement, and the user chooses a password with 10 characters. The user enters the number “10” in answer to the prompt from the cipher algorithm. All 10 characters begin as global characters. That is, all 10 characters may be assigned any of a letter, a number, or a special character. Some of these global characters may change status, and become assigned characters, meaning that they may only be one type of character, as is further described below.

The cipher algorithm, as shown in Step 214, through the same or another window, or on the display on the keyboard, may then prompt the user if there is a requirement that the password include capital letters. The user may enter either a “yes” or “no” answer in the form of a corresponding “y” or “n” keystroke. Next, the cipher algorithm may prompt the user to enter how many capital letters are required. This prompt is delivered in the same manner as the other prompts in this example. The user would then enter a number value. Continuing with the previous example, the user may understand that the password is required to have one capital letter. Correspondingly, the user may enter “y” to the first prompt, and “1” to the second.

The cipher algorithm, based on the input of “y” and “1” may then run a random number generator to produce a number between 1 and 10. For example, the random number generator may output the number nine. The algorithm takes this result and tags the ninth character in the password as being an assigned character, having a requirement to be a capital letter. Alternatively, the cipher algorithm may prompt the user, asking if the user wishes to choose which character will be the capital letter. Further, the prompt may allow a response that the user does not wish to specify which character, and the algorithm then proceeds as described above with running the random number generator.

As shown in Step 216, the cipher algorithm may next prompt the user if there are any numbers required in the password. The user may again enter either a “yes” or “no” answer in the form of a corresponding “y” or “n” keystroke. Next, if the user indicated in the positive that the password required numbers, the cipher algorithm may prompt the user to enter how many numbers are required. This prompt is delivered in the same manner as the other prompts in this example. The user may then enter a number value indicating how many numbers are required to be in the password. For example, the user may enter “2,” indicating that the password requires two numbers.

Continuing with the example, the cipher algorithm, based on the input of “y” and “2” then runs a random number generator twice in order to produce two numbers between 1 and 10. If the result is nine, then the random number generator is run as many additional times as required to produce two results, neither of which is a nine, because the ninth character position has already been assigned as a capital letter. For example, the random number generator may output the number five, corresponding to the fifth character position. Next, the random number generator may output the number nine, corresponding to the ninth character position. The cipher algorithm ignores this result and runs the random number generator again. This time the random number generator outputs a two, corresponding to the second character position. The algorithm takes this pair of results and tags the second and fifth character positions in the password as being assigned character positions, specifically, having an assigned ruleset, in this case a number ruleset. The tagging by the cipher algorithm attaches a ruleset to that character that causes a reduced set of characters to scroll for that keystroke. Specifically, for the second and fifth characters only numbers will scroll, excluding numbers previously assigned to either global character slots or other assigned character slots. Alternatively, the cipher algorithm may prompt the user if the user wishes to choose which characters will be the numbers. Further, the prompt may allow a response that the user does not wish to specify which characters will be numbers, and the algorithm then proceeds as described above with running the random number generator.

As shown in Step 218, the cipher algorithm may next prompt the user about whether the password requires any special characters. As with all of the other prompts, this prompt may be in the form of a question either on a software window displayed on a computer display, or on a display integral with the keyboard. The user may again enter either a “yes” or “no” answer in the form of a corresponding “y” or “n” keystroke. Alternatively, for this response or any of the others, the software version may include radio buttons which may be clicked. Next, if the user indicated in the positive that the password required special characters, the cipher algorithm may prompt the user to enter how many special characters are required. This prompt is delivered in the same manner as the other prompts in this example. The user may then enter a number value indicating how many special characters are required to be in the password. For example, the user may enter “2,” indicating that the password requires two special characters.

The cipher algorithm may further prompt a user to enter the available special characters. Many password systems exclude some special characters on the keyboard, limiting the available special characters to a specified group. Alternatively, there may be no restricted special characters, and the user may enter as many as they wish, but the user is not required to list any. Thus, the user may choose the group of special characters, and limit the group to less than all the available special characters if the user wishes.

Once the user has input the group of available special characters, the cipher algorithm may distribute the special characters in the cipher by assigning the special characters to represent one of the letters of the unencoded, or plain text, alphabet. The rules for distributing the special characters may establish a priority list for placement of the special characters in the cipher in relation to the letters of the unencoded, or plain text, alphabet. The ruleset may include that if there is at least one special character, then the letter “h” may receive a second character in addition to the single character already assigned. If there are two special characters, the letter “r” may receive a second character in addition to the single character already assigned. The entirety of the priority list for assigning letters may be, in order of priority from highest to lowest, h, r, e, t, a, o, i, n, and s. If there are additional special characters, the priority list may repeat, meaning that additional characters may be assigned, in order, to h, r, e, t, a, o, i, n, and s. If the list has repeated twice, an additional character may be assigned to the letter “d” before additional characters are assigned to the above priority list again. If there are still more special characters, the letter “d” may receive another cipher character, and then the priority list repeated again for additional assignments until all cipher characters are assigned to plain text characters. The special characters may be taken from the entered group in the order in which they were entered by the user when prompted.

Continuing with the example, the cipher algorithm, based on the input of “y” and “2” then runs a random number generator twice in order to produce two numbers between 1 and 10. If the result is two, five, or nine, then the random number generator is run as many additional times as required to produce two results, neither of which is a two, five, or nine. Two, five, and nine must be excluded because the second and fifth characters are already assigned number characters, and the ninth character is already an assigned capital letter character. For example, the random number generator may output the number six. Next, the random number generator may output the number nine. The cipher algorithm ignores this result and runs the random number generator again. This time the random number generator outputs a two. Then random number generator also ignores this result and runs again. The random number generator then outputs a three, corresponding to the third character position. The algorithm takes this pair of results and tags the third and sixth character positions in the password as being assigned character positions, specifically, having a requirement to be one of the input special characters. The tagging by the cipher algorithm attaches a ruleset to that character position that causes a reduced set of characters to scroll for that character position. Specifically, for the third and sixth characters only the input special characters will scroll, excluding any special characters previously assigned to either global character slots or other assigned character slots. Alternatively, the cipher algorithm may prompt the user if the user wishes to choose which characters will be assigned as special characters. Further, the prompt may allow a response that the user does not wish to specify which characters will be numbers, and the algorithm then proceeds as described above with running the random number generator.

Once all of the above has been input, as shown in Step 220, the group or list of available cipher characters is set through the input, and the cipher algorithm prompts the user to begin entering the password. Almost immediately, as shown in Step 222, the cipher algorithm begins cycling through all of the available characters for the first character position. The available characters depend on whether the first character position has been designated a global character position, or an assigned position. Global character positions may be assigned any character not already assigned. Assigned positions are subject to one of a plurality of rulesets which limit that character position to a type of character. The type of character for an assigned character position may be a capital letter, a number, or a special character, for example.

Continuing with the above example, the first character of the ten character positions is a global character position. Therefore, all of the letters of the alphabet, any of the digits, and any of the group of input special characters, if any special characters were input, are available for assignment via keystroke. All of the above are scrolling through at whatever time interval has been chosen. For example, each character may be available for a tenth of a second. Alternatively, availability of characters for less than a tenth of a second and more than a tenth of a second are contemplated. As shown in Step 224, when the user makes the keystroke, the currently available cipher character is selected, and added to the password in character position one. Further, the cipher character in position one in the password is keyed to the typed plain text, or unencoded, letter as the first step in creating the cipher.

As shown in Step 226, the cipher algorithm then moves to the second character position. Continuing with the same example, the second character position is an assigned position. Specifically, the second character position is assigned as a number character. Therefore, the cipher algorithm follows a ruleset which requires that only the numbers not previous assigned are randomized and each made available, in order, for a limited time period. As above, each may be available for a tenth of a second. Time periods of less than a second and more than a second are also contemplated. This process of making the characters available for a limited time period, in order, may herein be called scrolling. Just as with the letters of the alphabet, the assignable characters do not scroll in order, that is, a-z and 0-9. Rather, the letter and number order is randomized by the cipher algorithm before scrolling begins. Thus, if a number was not selected in position one, then all of the randomized digits scroll before the user makes a keystroke. If a number was selected in position one, then that number is excluded from the scrolling numbers in position two. Alternatively, if a number was chosen in character position one of the password, the assignment of character position two may be removed, and instead become a global character position. Once the user makes a keystroke, a number may be assigned to character position two of the password. The number, as a cipher character, may be further associated with the plain text, or unencoded, letter typed by the user to further establish the cipher.

The cipher algorithm then moves to the third character position. Continuing with the example, the third character position is an assigned position. Specifically, the third character position is assigned as a special character position. Therefore, the cipher algorithm follows a ruleset which requires that only the special characters not previous assigned scroll in a randomized set. That is, just as with the letters of the alphabet and the digits, the assignable special characters do not scroll in any order, for example the order in which they were entered when the cipher algorithm prompted the user to do so. Rather, the special character order is randomized by the cipher algorithm before scrolling begins. Thus, if a special character was not selected in position one, then all of the randomized special characters scroll before the user makes a keystroke. If a special character was selected in position one, then that special character is excluded from the scrolling special characters in position three. Alternatively, if a special character was chosen in character position one of the password, the assignment of character position three may be removed, and character position three may instead become a global character position. Once the user makes a keystroke, a special character may be assigned to character position three of the password. The special character may be further associated with the plain text, or unencoded, letter typed by the user to further establish the cipher.

The cipher algorithm next moves on to the fourth character position. The fourth character position is similar to the first character position in that the fourth character position is also a global character position. Thus, the entirety of the randomized letters, numbers, and special characters which have not been assigned to a previous character position are scrolled for the fourth character position. As with the previous character positions, and particularly character position one, the reduced list of randomized characters scrolls, and the user executes a keystroke. The keystroke assigns the currently available cipher character to the plain text typed letter, further generating the cipher.

Once the fourth password character position character is assigned, the cipher algorithm moves on to the fifth password character position. Continuing with the example, the fifth character position is again an assigned position. Specifically, the fifth character position is assigned as a number character. Therefore, the cipher algorithm follows a ruleset which requires that only the numbers not previous assigned scroll randomly. That is, just as with the letters of the alphabet, the assignable characters do not scroll in order, that is, a-z and 0-9. Rather, the letter and number order is randomized by the cipher algorithm before scrolling begins. Thus, any number selected in positions one through four is not included in the randomized digits which scroll prior to the user making a keystroke. If a number was selected in any of positions one through four, then that number is excluded from the scrolling numbers in position five. Of course, it is certain that at least one number was selected in this example, because password character position two was an assigned character position. Alternatively, if a number was chosen in global character positions one or four of the password, the assignment of character position five may be removed, and character position five may instead become a global character position. Once the user makes a keystroke, a number is assigned to character position five of the password. The number is further associated with the plain text, or unencoded, letter typed by the user to further establish the cipher by keying the number to the letter typed by the user on the keyboard.

Once the fifth password character position is assigned, the cipher algorithm then moves to the sixth character position. Continuing with the example, the sixth character position is an assigned position. Specifically, the sixth character position is assigned as a special character position. Therefore, the cipher algorithm follows a ruleset which requires that only the special characters not previous assigned scroll randomly and may be selected for assignment. That is, just as with the third password character position, any special character selected in either of global character positions one or four, or special character assigned position three, then that special character is excluded from the scrolling numbers in position six. Of course, it is certain that at least one special character was selected in this example, because password character position three was an assigned character position. Alternatively, if a special character was chosen in character positions one or four of the password, the assignment of character position six may be removed, and instead character position six may become a global character position. Assuming the sixth character position is not made global, and continuing with the example, the special character order is randomized by the cipher algorithm before scrolling begins. All of the randomized special characters except for the special character assigned to password character position three, and any special characters that may have been assigned in global positions one and four, scroll before the user makes a keystroke. Once the user makes a keystroke, a special character may be assigned to character position six of the password. The special character may be further associated with the plain text, or unencoded, letter typed by the user to further establish the cipher by keying the number to the letter typed by the user on the keyboard.

Once the sixth password character position is assigned, the cipher algorithm then moves to the seventh character position. Continuing with the example, the seventh character position is a global position. Thus, the entirety of the randomized letters, numbers, and special characters which have not been assigned to a previous character position are scrolled for the seventh character position. The reduced list of randomized characters scrolls, and the user executes a keystroke. The keystroke assigns the currently available cipher character to the typed plain text, or unencoded, letter, further generating the cipher.

Once the seventh password character position is assigned, the cipher algorithm then moves to the eighth character position. Continuing with the example, the eighth character position is a global position. Thus, the entirety of the randomized letters, numbers, and special characters which have not been assigned to a previous character position are scrolled for the eighth character position. The reduced list of randomized characters scrolls, and the user executes a keystroke. The keystroke assigns the currently available cipher character to the typed plain text, or unencoded, letter, further generating the cipher.

Once the eighth password character position is assigned, the cipher algorithm then moves to the ninth character position. Continuing with the example, the ninth character position is an assigned character position. Specifically, the ninth character position is a capital letter position. The ruleset for the capital letter position on allows any remaining cipher letters to scroll, and when one of those letters is assigned by keystroke of the user, assigns the capitalized letter to the character position. Thus, the entirety of the randomized letters which have not been assigned to a previous character position are scrolled for the ninth character position. The reduced list of randomized characters scrolls, and the user executes a keystroke. The keystroke assigns the currently available cipher character to the typed plain text, or unencoded, character, further generating the cipher.

Once the ninth password character position is assigned, the cipher algorithm then moves to the tenth character position. Continuing with the example, the tenth character position is a global character position. Thus, the entirety of the randomized letters, numbers, and special characters which have not been assigned to a previous character position may be scrolled for the tenth character position. The reduced list of randomized characters scrolls, and the user executes a keystroke. The keystroke assigns the current cipher character to the typed character, completing the user portion of generating the cipher.

Once all the characters of the password are generated using the dynamic cipher, the cipher algorithm still has several cipher characters that have not been assigned to any of the plain text characters. Once the user completes all the keystrokes which assign at least one cipher character to each of the typed characters, then the cipher algorithm continues, using a ruleset to assign the unassigned characters.

The cipher algorithm further includes a ruleset which assigns the remaining cipher algorithm characters to the remaining plain text characters. A typical homophonic substitution uses the digits 0-9 in addition to the letters of the alphabet. Because this is more than 26 characters total, the homophonic substitution in a mixed alphabet cipher assigns two characters to the letter “a,” four characters to the letter “e,” two to the letter “i,” two to the letter “n,” two to the letter “o,” two to the letter “s,” and two to the letter “t.” The special characters simply add to the total. Because it is not known exactly how many special characters may be included before a user enters them, the cipher algorithm may include a ruleset as to which alphabet letters get assigned either a second, or more, character of the pool of special characters.

The rules for distributing the special characters may establish a priority list for placement of the special characters in the cipher in relation to the letters of the unencoded alphabet. The ruleset may include that if there is at least one special character, then the letter “h” may receive a second cipher character in addition to the single cipher character already assigned. If there are two special characters, the letter “r” may receive a second cipher character in addition to the single cipher character already assigned. The entirety of the priority list for assigning letters may be, in order of priority from highest to lowest, h, r, e, t, a, o, i, n, and s. If there are additional special characters, the priority list may repeat, meaning that special characters may be assigned, in order, to h, r, e, t, a, o, i, n, and s. If the list has repeated twice, a second cipher character may be assigned to the letter “d” before additional cipher characters are assigned to the above priority sequence again.

Returning to the example, 10 characters will be assigned within the cipher during the password creation process. 26 characters will remain if there are no special characters, and more than 26 will remain if there are special characters being used. Using a random number generator to designate, one at a time, the remaining characters, the above ruleset assigns the remaining characters according to the above ruleset. Once all the characters have been assigned, the cipher is complete.

As shown in Steps 228 and 230, the cipher may be stored in a secure file and uploaded offsite. The secure file may be uploaded to the cloud, or to an offsite server, or a peer machine with separate security, or any machine other than the local machine on which it was created. The secure file may include information which associates the cipher and the files with which the cipher is to be used. The cipher may be used with only one file or it may be used with a plurality of files. This option may be user controllable. Upon creation of the secure file, a pointer may be added to the local software associating the secure file to every file, including websites, with which it is to be used. A pointer may be added to the software on the local machine used in conjunction with the cipher and the secure file on which it is stored. When a file is opened which has a password associated with it, the pointer in the software may reach out to the secure file, obtaining the cipher and placing the cipher in to operation. As the user types the password associated with the file, the cipher encodes the typed password in to the password used with the file.

A number of nonlimiting example embodiments based on the above description are provided below.

In a 1st example, a method for encoding passwords using a dynamic cipher, comprising: loading a cipher algorithm on to a non-transient memory; inputting a total number of characters included in a password to the cipher algorithm; inputting whether one or more capital letters are required for inclusion in the password, and if the input indicates capital letters are required for inclusion, how many capital letters are required for inclusion; inputting whether one or more numbers are required for inclusion in the password, and if the input indicates numbers are required for inclusion, how many numbers are required for inclusion; inputting whether one or more special characters are required for inclusion in the password, and if the input indicates numbers are required for inclusion, inputting the special characters available for inclusion; forming the alphabet, digits 0 through 9, and the special characters, if any are input, in to a group of available cipher characters;

scrolling, automatically, through the group of available cipher characters, each cipher character in the group of available cipher characters available for assignment by keystroke during a predetermined time interval; initiating the creation of the cipher by assigning the cipher character available for assignment to a plain text letter by making a keystroke on an input device;

executing additional keystrokes to assign characters available for assignment to each of the other characters of the password; and creating a secure file including the cipher.

In a 2nd example, the method of Example 1, wherein the group of available characters is randomly ordered.

In a 3rd example, the method of any of Examples 1-2, further comprising storing the secure file in the cloud.

In a 4th example, the method of any of Examples 1-3, further comprising storing the secure file on a server remote from computing device.

In a 5th example, the method of any of Examples 1-4, wherein each of the capital letters, if any, are assigned a character position within the password by a random number generator.

In a 6th example, the method of any of Examples 1-5, wherein each of the numbers, if any, are assigned a character position within the password by a random number generator.

In a 7th example, the method of any of Examples 1-6, wherein each of the special characters, if any, are assigned a character position within the password by a random number generator.

In a 8th example, a method for encoding passwords using a dynamic cipher, comprising: loading a cipher algorithm on to a non-transient memory; inputting a total number of characters included in a password to the cipher algorithm; inputting character type requirements within the password to the cipher algorithm; forming the alphabet, digits 0 through 9, and the special characters, if any are input, in to a group of available cipher characters; scrolling, automatically, through the group of available cipher characters, each cipher character in the group of available cipher characters available for assignment by keystroke during a predetermined time interval; initiating the creation of the cipher by assigning the cipher character available for assignment to a plain text letter by making a keystroke on an input device attached to a computing device; executing additional keystrokes to assign cipher characters available for assignment to each of the other characters of the password; and creating a secure file including the cipher.

In a 9th example, the method of Example 8, wherein the character type requirements within the password whether the password requires capital letters, numbers, or special characters, or a combination of some or all of the capital letters, numbers, and special characters.

In a 10th example, the method of Example 9, wherein the character type requirements within the password further include, if the password requires capital letters, numbers, or special characters, or a combination of some or all of the capital letters, numbers, and special characters, a specific number of each type required.

In a 11th example, the method of Example 10, wherein for each of the required of the capital letters, numbers, and special characters, a random number generator determines a character position within the password, and assigns a ruleset to that character position for the type of character determined for that character position.

In a 12th example, the method of any of Examples 8-11, further including assigning, by the cipher algorithm, the unassigned characters to plain text letters to complete the cipher.

In a 13th example, a method for dynamically creating a second password from a first password, comprising: determining a total number of characters in a password; assigning positions to each character in the password; determining requirements for the password, including a number of capital letters, a number of digits, and a number of special characters; inputting, if any are required, a list of special characters; using a random number generator determining a character position for each of the capital letters, digits, and special characters required; assigning one of a corresponding capital letter, digit, and special character ruleset to each of the assigned positions within the password; assigning a global ruleset to the each of the unassigned character positions within the password; using the letters of the alphabet, digits 0 through 9, and, if required, the input list of special characters to create a set of cipher characters; randomizing the set of cipher characters; changing the cipher character available for assignment according to the ruleset assigned to each character position through a keystroke by maintaining the availability of each of the cipher characters in the set of cipher characters for a predetermined time period; and assigning the password by making a keystroke of an input device for each of the character positions in the password, the keystroke assigning one cipher character of the set of cipher characters to the plain text character corresponding to the input device key.

In a 14th example, the method of Example 13, further comprising assigning each of the unassigned cipher characters in the set of cipher characters to a plain text character according to an assignment ruleset.

In a 15th example, the method of Example 14, wherein the completed cipher is stored in a secure computer file in a remote location.

In a 16th example, the method of any of Examples 13-15, wherein the predetermined time period is one tenth of a second.

In a 17th example, the method of any of Examples 13-16, wherein the cipher algorithm ignores previously assigned character positions in assigning further assigned character positions.

In a 18th example, the method of any of Examples 15-17, wherein the secure computer file includes a pointer back to the files with which the cipher is associated.

In a 19th example, the method of any of Examples 13-18, wherein the total number of characters are input by a user.

In a 20th example, the method of any of Examples 13-19, wherein the number ruleset will only allow numbers not previously assigned in one of the global character positions or one of the assigned character positions to be assigned by a keystroke.

The above description is given by way of example, and not limitation. Given the above disclosure, one skilled in the art could devise variations that are within the scope and spirit of the invention disclosed herein, including various ways of forming the authenticity function. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for encoding passwords using a dynamic cipher, comprising:
loading a cipher algorithm on to a non-transient memory;
inputting a total number of characters included in a password to the cipher algorithm;
inputting whether one or more capital letters are required for inclusion in the password, and if the input indicates capital letters are required for inclusion, how many capital letters are required for inclusion;
inputting whether one or more numbers are required for inclusion in the password, and if the input indicates numbers are required for inclusion, how many numbers are required for inclusion;
inputting whether one or more special characters are required for inclusion in the password, and if the input indicates numbers are required for inclusion, inputting the special characters available for inclusion;
forming the alphabet, digits 0 through 9, and the special characters, if any are input, in to a group of available cipher characters;
scrolling, automatically, through the group of available cipher characters, each cipher character in the group of available cipher characters available for assignment by keystroke during a predetermined time interval;
initiating the creation of the cipher by assigning the cipher character available for assignment to a plain text letter by making a keystroke on an input device;
executing additional keystrokes to assign characters available for assignment to each of the other characters of the password; and
creating a secure file including the cipher.

2. The method of claim 1, wherein the group of available characters is randomly ordered.

3. The method of claim 1, further comprising storing the secure file in the cloud.

4. The method of claim 1, further comprising storing the secure file on a server remote from computing device.

5. The method of claim 1, wherein each of the capital letters, if any, are assigned a character position within the password by a random number generator.

6. The method of claim 1, wherein each of the numbers, if any, are assigned a character position within the password by a random number generator.

7. The method of claim 1, wherein each of the special characters, if any, are assigned a character position within the password by a random number generator.

8. A method for encoding passwords using a dynamic cipher, comprising:
loading a cipher algorithm on to a non-transient memory;
inputting a total number of characters included in a password to the cipher algorithm;
inputting character type requirements within the password to the cipher algorithm;
forming the alphabet, digits 0 through 9, and the special characters, if any are input, in to a group of available cipher characters;
scrolling, automatically, through the group of available cipher characters, each cipher character in the group of available cipher characters available for assignment by keystroke during a predetermined time interval;
initiating the creation of the cipher by assigning the cipher character available for assignment to a plain text letter by making a keystroke on an input device attached to a computing device;
executing additional keystrokes to assign cipher characters available for assignment to each of the other characters of the password; and
creating a secure file including the cipher.

9. The method of claim 8, wherein the character type requirements within the password whether the password requires capital letters, numbers, or special characters, or a combination of some or all of the capital letters, numbers, and special characters.

10. The method of claim 9, wherein the character type requirements within the password further include, if the password requires capital letters, numbers, or special characters, or a combination of some or all of the capital letters, numbers, and special characters, a specific number of each type required.

11. The method of claim 10, wherein for each of the required of the capital letters, numbers, and special characters, a random number generator determines a character position within the password, and assigns a ruleset to that character position for the type of character determined for that character position.

12. The method of claim 8, further including assigning, by the cipher algorithm, the unassigned characters to plain text letters to complete the cipher.

13. A method for dynamically creating a second password from a first password, comprising:
determining a total number of characters in a password;
assigning positions to each character in the password;
determining requirements for the password, including a number of capital letters, a number of digits, and a number of special characters;
inputting, if any are required, a list of special characters;
using a random number generator determining a character position for each of the capital letters, digits, and special characters required;
assigning one of a corresponding capital letter, digit, and special character ruleset to each of the assigned positions within the password;
assigning a global ruleset to the each of the unassigned character positions within the password;
using the letters of the alphabet, digits 0 through 9, and, if required, the input list of special characters to create a set of cipher characters;
randomizing the set of cipher characters;
changing the cipher character available for assignment according to the ruleset assigned to each character position through a keystroke by maintaining the availability of each of the cipher characters in the set of cipher characters for a predetermined time period; and
assigning the password by making a keystroke of an input device for each of the character positions in the password, the keystroke assigning one cipher character of the set of cipher characters to the plain text character corresponding to the input device key.

14. The method of claim 13, further comprising assigning each of the unassigned cipher characters in the set of cipher characters to a plain text character according to an assignment ruleset.

15. The method of claim 14, wherein the completed cipher is stored in a secure computer file in a remote location.

16. The method of claim 13, wherein the predetermined time period is one tenth of a second.

17. The method of claim 13, wherein the cipher algorithm ignores previously assigned character positions in assigning further assigned character positions.

18. The method of claim 15, wherein the secure computer file includes a pointer back to the files with which the cipher is associated.

19. The method of claim 13, wherein the total number of characters are input by a user.

20. The method of claim 13, wherein the number ruleset will only allow numbers not previously assigned in one of the global character positions or one of the assigned character positions to be assigned by a keystroke.
